(19) United States
(12) Patent Application Publication
(10) Pub. No.: US 2024/0166010 A1
(43) Pub. Date: May 23, 2024

(54) MOBILE ROBOT DRIVING WHEEL DEFORMING DEVICE AND MOBILE ROBOT COMPRISING SAME

(71) Applicant: HOSEO UNIVERSITY ACADEMIC COOPERATION FOUNDATION, Chungcheongnam-do (KR)

(72) Inventor: Young Eun SONG, Chungcheongnam-do (KR)

(21) Appl. No.: 18/283,310

(22) PCT Filed: Mar. 23, 2022
(86) PCT No.: PCT/KR2022/004083

§ 371 Date: Sep. 21, 2023

(30) Foreign Application Priority Data
Mar. 24, 2021 (KR) 10-2021-0038134

(51) Int. Cl. B60G 17/0165; B60G 7/00; A61G 5/06

(52) U.S. Cl. CPC B60G 17/0165; B60G 7/001; A61G 5/061; B60G 2300/24; B60G 2300/26

(57) ABSTRACT

A mobile robot driving wheel deforming device is capable of changing a wheel base and a mobile robot comprising same. To this end, provided is a mobile robot (100) driving wheel deforming device comprising: a first driving wheel (200) for driving the mobile robot (100); a third arm (152) connected to the first driving wheel (200); a second driving wheel (210) for driving the mobile robot (100); a fourth arm (154), one end of which is connected to the second driving wheel (210), and the other end of which is connected to the third arm (152) such that same rotates integrally; a third driving wheel (220) for driving the mobile robot (100); a second arm (114), one end of which is connected to the third driving wheel (220); a second shaft (150) installed in an area in which the third arm (152) and the fourth arm (154) are connected, thereby rotating the third arm (152) and the fourth arm (154); and a second-shaft servomotor (330) for rotating the second shaft (150).

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2022/004083, filed Mar. 23, 2022, which claims priority to the benefit of Korean Patent Application No. 10-2021-0038134 filed in the Korean Intellectual Property Office on Mar. 24, 2021, the entire contents of which are incorporated herein by reference.

### BACKGROUND

### 1. Technical Field

The present invention relates to a mobile robot capable of moving in narrow areas while overcoming obstacles and, more specifically, to a mobile robot driving wheel deforming device capable of changing a wheel base and a mobile robot comprising same.

### 2. Background Art

In general, wheeled operating devices (automated guided vehicles (AGVs)), transportation means (automobiles), and robots can travel smoothly on a flat ground, but hardly overcome or cannot overcome obstacles such as a stair, an unpaved road, a bare land, a door sill, and a rough road.

In order to overcome these shortcomings, a caterpillar method was proposed. However, the caterpillar method has a complicated structure, has difficulties in high-speed driving, and is inefficient in maintenance due to the large number of components.

In addition, a conventional mobile robot has a fixed wheel base which equals a distance between a wheel and a wheel. Hence, in narrow corridors or alleyways, there were many restrictions on the mobile robot's U-turn, turn, or change of direction. In addition, in a case of a mobile robot that employs six or more wheels, the mobile robot cannot board an elevator due to a long wheel base.

Examples of the related art include Korean Utility Model Registration No. 20-0232858 (Wheelchair Belt Tire System) and Korean Unexamined Patent Publication No. 10-2009-0103357 (Wheelchair for Climbing Stair and Wheel Thereof).

### SUMMARY

Hence, the present invention is conceived to solve the problems described above, and objects to be achieved by the present invention are to provide a mobile robot driving wheel deforming device capable of driving on rough terrain such as an unpaved road, a hill-side road, and an outdoor land and overcoming obstacles such as a stair and a door sill, and a mobile robot including the same.

Other objects of the present invention are to provide a mobile robot driving wheel deforming device capable of driving even in a small space by enabling a wheel base to be deformed, and a mobile robot including the same.

However, technical objects to be achieved by the present invention are not limited to the technical objects mentioned above, and the following description enables still other unmentioned technical objects to be clearly understood by a person of ordinary skill in the art to which the present invention pertains.

In order to achieve a technical object described above, there is provided a mobile robot 100 driving wheel deforming device including: a first driving wheel 200 for driving the mobile robot 100; a third arm 152 connected to the first driving wheel 200; a second driving wheel 210 for driving the mobile robot 100; a fourth arm 154, one end of which is connected to the second driving wheel 210, and the other end of which is connected to the third arm 152 such that same rotates integrally; a third driving wheel 220 for driving the mobile robot 100; a second arm 114, one end of which is connected to the third driving wheel 220; a second shaft 150 installed in an area in which the third arm 152 and the fourth arm 154 are connected, thereby rotating the third arm 152 and the fourth arm 154; and a second-shaft servomotor 330 for rotating the second shaft 150.

In addition, the other end of the second arm 114 is connected to the mobile robot 100.

In addition, the third arm 152 and the fourth arm 154 are connected to form an angle in a range of 60° to 120° therebetween.

In addition, the second-shaft servomotor 330 may rotate the second shaft 150 in a range of 30° to 60°.

In addition, the first driving wheel 200 projects more forward than the mobile robot 100 or is positioned at the same location as the front.

In addition, the third driving wheel 220 is positioned to project more rearward than the mobile robot 100.

In addition, the first driving wheel 200, the second driving wheel 210, and the third driving wheel 220 are sequentially positioned from front to rear of the mobile robot 100.

Another object of the present invention can be achieved by a mobile robot including the driving wheel deforming device described above.

In addition, the mobile robot may be one of a logistics robot, an electric cart, an automated guided vehicle, and a wheelchair.

According to an embodiment of the present invention, the mobile robot can travel on rough terrain such as an unpaved road, a hill-side road, and an outdoor land and can overcome obstacles such as a stair and a door sill. This enables an efficient delivery to be achieved when the present invention is applied to a logistics robot.

In addition, since a wheel base which equals a distance between a driving wheel and a driving wheel can be changed, the mobile robot can make a U-turn, a turn, or a change of direction even in a narrow corridor or an alleyway. In addition, even in a case of a mobile robot that employs six or more wheels, the mobile robot can board an elevator because the wheel base can be changed.

However, effects to be achieved by the present invention are not limited to the effects mentioned above, and the following description enables other unmentioned effects to be clearly understood by a person of ordinary skill in the art to which the present invention pertains.

### BRIEF DESCRIPTION OF THE DRAWINGS

The following drawings accompanied in this specification illustrate a preferred embodiment of the present invention and are provided to cause the technical idea of the present invention to be better understood with the detailed description of the invention to be described below, and thus the present invention is not to be construed by being limited only to illustration of the drawings.

FIG. 1 is a side view illustrating a state when a mobile robot 100 including a driving wheel deforming device travels on a flat ground according to an embodiment of the present invention.

FIG. 2 is a side view illustrating a state in which the mobile robot 100 illustrated in FIG. 1 climbs an obstacle 60.

FIG. 3 is a side view illustrating a state in which the mobile robot 100 illustrated in FIG. 1 moves in a small area by decreasing a wheel base.

FIG. 4 is a schematic internal block diagram of the mobile robot 100 including the driving wheel deforming device according to the embodiment of the present invention.

### DETAILED DESCRIPTION

Hereinafter, embodiments of the present invention will be described with reference to the accompanying drawings and in detail to the extent that a person with ordinary knowledge in the art to which the present invention pertains can easily implement the embodiments of the present invention. However, since the description of the present invention is provided for only an embodiment for describing structural or functional description, the scope of the claims of the present invention is not to be construed as limited by the embodiments described herein. That is, since the embodiment can be variously modified and can have various forms, the scope of the claims of the present invention is to be understood to include equivalents capable of realizing technical ideas. In addition, since objects or effects presented in the present invention do not mean that a specific embodiment is to include all of the objects or the effects or include only the effects, the scope of the claims of the present invention is not to be construed as limited thereby.

Meanings of terms provided herein are to be understood as follows.

Terms such as “first” and “second” are used to distinguish one configurational element from another configurational element, and the scope of the claims is not to be limited by these terms. For example, a first configurational element can be named as a second configurational element, and similarly, the second configurational element can also be named as the first configurational element. The description in which one configurational element is mentioned to be “connected to” another configurational element is to be understood to mean that the one configurational element can be directly connected to the other configurational element, or that still another configurational element can be present therebetween. On the other hand, the description in which one configurational element is “directly connected to” another configurational element is to be understood to mean that no configurational element is present therebetween. Meanwhile, the same is true of other expressions, that is, “between” and “directly between”, “adjacent” and “directly adjacent”, or the like for describing relationships between configurational elements.

An expression with a singular form is construed to include a meaning of a plural form thereof, unless obviously implied otherwise in context. Terms such as “comprise” or “have” are to be construed to specify that a feature, a number, a step, an operation, a configurational element, a member, or a combination thereof described herein is present and are not to exclude presence or a possibility of addition of one or more other features, numbers, steps, operations, configurational elements, members, or combinations thereof in advance.

Unless otherwise defined, all terms used herein have the same meanings as meanings generally understood by a person of ordinary skill in the art to which the present invention pertains. The same terms as those defined in a generally used dictionary are to be construed as having the same meanings as the contextual meanings in the related art. In addition, unless clearly defined in the present invention, the terms are not to be construed as having ideal or excessively formal meanings.

### Configurations of Embodiments

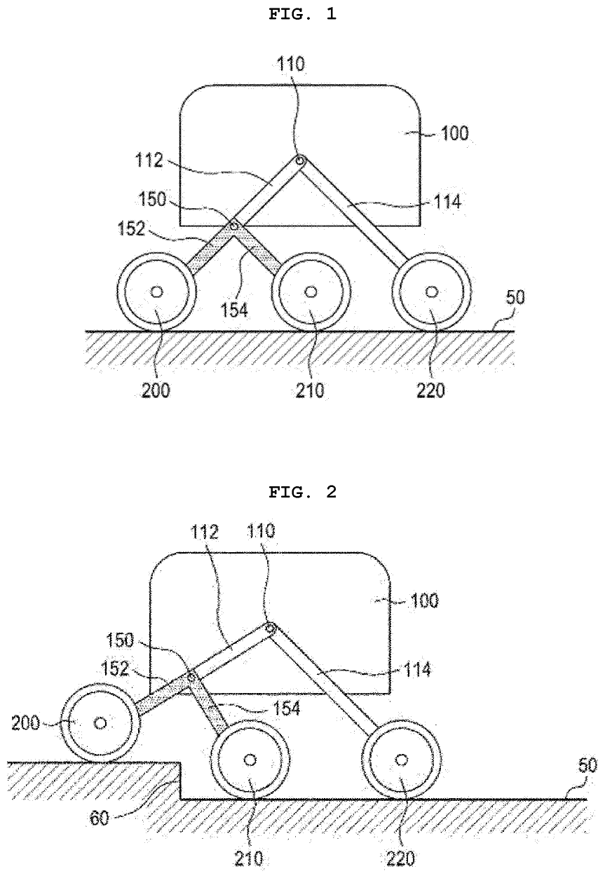

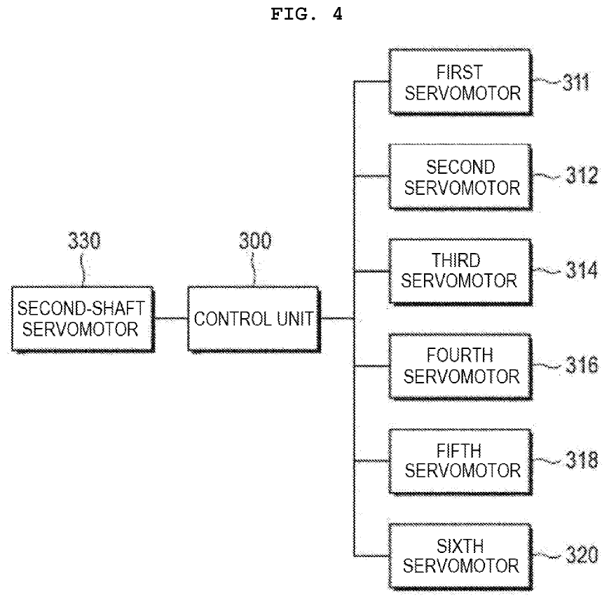

Hereinafter, configurations of preferred embodiments will be described in detail with reference to the accompanying drawings. FIG. 1 is a side view illustrating a state when a mobile robot 100 including a driving wheel deforming device travels on a flat ground according to an embodiment of the present invention, and FIG. 4 is a schematic internal block diagram of the mobile robot 100 including the driving wheel deforming device according to the embodiment of the present invention. As illustrated in FIGS. 1 and 4, the mobile robot 100 is an example of an autonomous driving device. Examples of specific applications of the mobile robot 100 can include an electric cart, a wheelchair, an automated guided vehicle (AGV), and the like.

The mobile robot 100 has a pair of first driving wheels 200 projecting forward. As the first driving wheels 200 project more forward than a front surface of the mobile robot 100, the first driving wheels can first come into contact with an obstacle 60 and climb the obstacle 60.

First and second servomotors 311 and 312 are connected to the pair of first driving wheels 200, and the pair of first driving wheels 200 can be rotated and steered independently. The pair of first driving wheels 200 can independently perform forward and reverse rotation.

The mobile robot 100 is equipped with a pair of second driving wheels 210 in a middle part thereof. Third and fourth servomotors 314 and 316 are connected to the pair of second driving wheels 210, and the pair of second driving wheels 210 can be rotated and steered independently. The pair of second driving wheels 210 can independently perform forward and reverse rotation. Optionally, the second driving wheel 210 can be an idle wheel.

The mobile robot 100 has a pair of third driving wheels 220 projecting rearward. As the third driving wheels 220 project more rearward than a rear surface of the mobile robot 100, the third driving wheels can first come into contact with the obstacle 60 and climb the obstacle 60.

Fifth and sixth servomotors 318 and 320 are connected to the pair of third driving wheels 220, and the pair of third driving wheels 220 can be rotated and steered independently. The pair of third driving wheels 220 can independently perform forward and reverse rotation.

The control unit 300 independently controls the first, second, third, fourth, fifth, and sixth servomotors 311, 312, 314, 316, 318, and 320 to cause the mobile robot 100 to implement driving, acceleration, deceleration, rotation in place, direction change, backing up, and a combination thereof. The first, second, third, fourth, fifth, and sixth servomotors 311, 312, 314, 316, 318, 320 can be in-wheel motors internally provided in the first, second, and third driving wheels 200, 210, and 220, respectively.

One end of a first arm 112 is connected to a first shaft 110, and the other end thereof is connected to a second shaft 150. One end of a second arm 114 is connected to the first shaft 110, and the other end thereof is connected to the third driving wheel 220. A suspension (not illustrated) can be attached to the first shaft 110. The first arm 112 and the second arm 114 can form a mutually constant angle (for example, 120°) therebetween. The first shaft 110 may be a fixed shaft that does not rotate.

One end of a third arm 152 is connected to the second shaft 150, and the other end thereof is connected to the first driving wheel 200. One end of a fourth arm 154 is connected to the second shaft 150, and the other end thereof is connected to the second driving wheel 210. The third and fourth arms 152 and 154 can be integrally configured to integrally rotate around the second shaft 150. The third arm 152 and the fourth arm 154 form an angle therebetween in a range of 60° to 120° therebetween. When the angle is smaller than 60°, a distance between the first and second driving wheels 200 and 210 is narrow, and interference occurs or the driving stability deteriorates. When the angle exceeds 120°, a full height of the mobile robot 100 can be too low, and the front of the mobile robot 100 can be too lifted when the second shaft 150 turns, deteriorating the stability.

The second shaft 150 is located at a position lower than a height of the first shaft 110 and is located more forward than the first shaft 110. The second shaft 150 is connected to a second-shaft servomotor 330, and the second-shaft servomotor 330 rotates the third and fourth arms 152 and 154 in response to a command of the control unit 300. The second-shaft servomotor 330 rotates the second shaft 150 at an angle in a range of 30° to 60°. When the angle is smaller than 30°, an effect of shortening the wheel base is insignificant, and when the angle exceeds 60°, the wheel base can be too shortened, resulting in a risk that the mobile robot 100 will fall forward.

Although six driving wheels are arranged in the mobile robot 100, the number of wheels can be further increased or decreased as necessary.

### Operations of Embodiments

Hereinafter, operations of preferred embodiments will be described in detail with reference to the accompanying drawings. First, on a ground surface 50 of a flat ground as illustrated in FIG. 1, the third and fourth arms 152 and 154 are arranged so that the first, second, and third driving wheels 200, 210, and 220 all come into contact with the ground surface 50. At this time, the wheel base (inter-shaft distance) between the first and third driving wheels 200 and 220 is maximized. In the same state as FIG. 1, high-speed driving or stable turning driving can be performed.

FIG. 2 is a side view illustrating a state in which the mobile robot 100 illustrated in FIG. 1 climbs an obstacle 60. As illustrated in FIG. 2, when the obstacle 60 such as a stair, a step, or a rough road is encountered, front parts of the first driving wheels 200 first come into contact with the obstacle 60 and climb the obstacle 60. Thereafter, the second and third driving wheels 210 and 220 sequentially climb over the obstacle 60. At this time, the second shaft 150 can rotate clockwise (based on FIG. 2) in a range of 10° to 30° to assist in overcoming the obstacle 60.

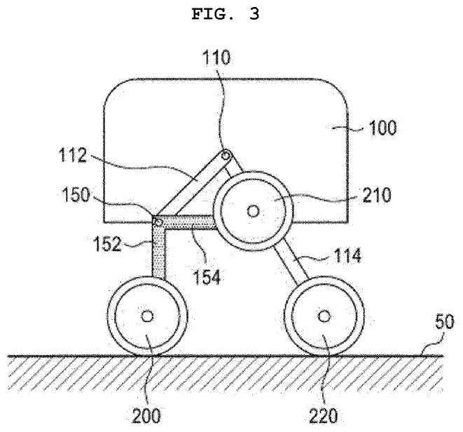

FIG. 3 is a side view illustrating a state in which the mobile robot 100 illustrated in FIG. 1 moves in a small area by decreasing the wheel base. As illustrated in FIG. 3, the second-shaft servomotor 330 rotates counterclockwise (based on FIG. 3) in response to a command of the control unit 300 so that the third arm 152 becomes vertical. At this time, the second driving wheel 210 is lifted by the fourth arm 154, and the wheel base is narrowed between the first driving wheel 200 and the third driving wheel 220.

Since the wheel base is narrowed, it is possible to make a change of direction or a turn in place even in a narrow corridor or an alleyway.

The detailed descriptions of preferred embodiments of the present invention disclosed as described above have been provided such that it is possible for those skilled in the art to implement and realize the present invention. Although the descriptions have been provided with reference to the desirable embodiments of the present invention, it will be understood that those skilled in the art can variously modify and change the present invention within a range without departing from the scope of the present invention. For example, those skilled in the art can use each of the configurations described in the above-described embodiments in a way of combining the configurations with each other. Hence, the present invention is not intended to be limited to the embodiments illustrated herein, but to provide a maximum range consistent with the principles and novel features disclosed herein.

The present invention can be embodied into another specific example within a range without departing from the idea and the essential feature of the present invention. Hence, the detailed descriptions are not to be construed to be limited in any aspects but is considered as an exemplary example. The scope of the present invention is determined through reasonable interpretation of the accompanying claims, and any modifications within an equivalent scope of the present invention are included in the scope of the present invention. The present invention is not to be limited to the embodiments illustrated herein, but to provide a maximum range consistent with the principles and novel features disclosed herein. In addition, any claims that do not have an explicit dependent relationship in the claims can be combined to configure an embodiment or be included as new claims by amendment after filing the application.

The mobile robot can travel on rough terrain such as an unpaved road, a hill-side road, and an outdoor land and can overcome obstacles such as stairs and door sills. This enables an efficient delivery to be achieved when the present invention is applied to a logistics robot.

1: A mobile robot driving wheel deforming device comprising:
a first driving wheel configured for driving the mobile robot;
a third arm connected to the first driving wheel;
a second driving wheel configured for driving the mobile robot;
a fourth arm, one end of which is connected to the second driving wheel, and the other end of which is connected to the third arm such that same rotates integrally;
a third driving wheel configured for driving the mobile robot;
a second arm, one end of which is connected to the third driving wheel;
a second shaft installed in an area in which the third arm and the fourth arm are connected, thereby rotating the third arm and the fourth arm; and
a second-shaft servomotor configured for rotating the second shaft.

2: The mobile robot driving wheel deforming device according to claim 1,
wherein the other end of the second arm is connected to the mobile robot.

3: The mobile robot driving wheel deforming device according to claim 1,
wherein the third arm and the fourth arm are connected to form an angle in a range of 60° to 120° therebetween.

4: The mobile robot driving wheel deforming device according to claim 1,
wherein the second-shaft servomotor rotates the second shaft in a range of 30° to 60°.

5: The mobile robot driving wheel deforming device according to claim 1,
wherein the first driving wheel projects more forward than the mobile robot or is positioned at the same location as the front.

6: The mobile robot driving wheel deforming device according to claim 1,
wherein the third driving wheel is positioned to project more rearward than the mobile robot.

7: The mobile robot driving wheel deforming device according to claim 1,
wherein the first driving wheel, the second driving wheel, and the third driving wheel are sequentially positioned from front to rear of the mobile robot.

8: A mobile robot comprising the driving wheel deforming device according to claim 1.

9: The mobile robot according to claim 8, wherein
the mobile robot is one of a logistics robot, an electric cart, an automated guided vehicle, and a wheelchair.
